(19) United States
(12) Patent Application Publication
(10) Pub. No.: US 2013/0159608 A1
(43) Pub. Date: Jun. 20, 2013

(54) BRIDGE CHIPSET AND DATA STORAGE SYSTEM

(71) Applicant: Young Kyun SHIN, Icheon-si (KR)

(72) Inventor: Young Kyun SHIN, Icheon-si (KR)

(73) Assignee: SK hynix Inc., Icheon-si (KR)

(21) Appl. No.: 13/604,421

(22) Filed: Sep. 5, 2012

(30) Foreign Application Priority Data
Dec. 19, 2011 (KR) 10-2011-0137484

(51) Int. Cl. G06F 12/02; G06F 12/00

(52) U.S. Cl. 711/103; 711/154; 711/104; 711/E12.001; 711/E12.008

(57) ABSTRACT

A data storage system includes: a data storage medium configured to store data; a main controller configured to control an operation of the data storage medium; and a bridge chipset configured to convert a signal provided from the main controller according to a control information provided from an external source to the data storage medium and the main controller and to provide the converted signal to the data storage medium.

### CROSS-REFERENCES TO RELATED APPLICATION

The present application claims priority under 35 U.S.C. §119(a) to Korean application number 10-2011-0137484, filed on Dec. 19, 2011, in the Korean Intellectual Property Office, which is incorporated herein by reference in its entirety.

### BACKGROUND

1. Technical Field

The present invention relates generally to a data storage system, and more particularly, to a data storage system having a bridge chipset.

2. Related Art

The modern computing paradigm is shifting to ubiquitous computing that can enable users with anytime and anywhere computing access. Accordingly, the uses of portable electronic devices such as mobile phones, portable media players (PMP), digital cameras, and notebook computers are on the rise. The data storage system in a portable electronic device typically utilizes a semiconductor memory device rather than a hard disk drive (HDD).

The semiconductor memory based data storage system does not require a mechanical driving unit. Thus, the semiconductor memory based data storage system tend to exhibit superior stability and durability, faster information access speed, and reduced power consumption. The examples of such semiconductor memory based data storage system include a Universal Serial Bus (USB) memory device, a memory card having various interfaces, and a solid state drive (SSD).

The storage medium in an SSD includes semiconductor memory devices. Similar to a HDD, an SSD is suited for use as a secondary memory device through an interface such as a parallel or serial advance technology attachment PATA or SATA. An SSD may be classified based on the type of a storage medium it uses, that is, for example, whether a volatile or nonvolatile memory device is used as the storage medium.

An SSD using a volatile memory device as a storage medium uses a high-speed volatile memory device, for example, SDRAM, to take advantage of the high data access speed. Therefore, a volatile memory device is used in an SSD as a storage medium mainly for increasing the speed of applications. An SSD in using a volatile memory device as a storage medium may include an internal battery and a backup system to maintain the data for a predetermined period of time.

An SSD using a nonvolatile memory device as a storage medium uses a large-capacity nonvolatile memory device, for example, a flash memory device for reasons that the storage capacity can be increased with relative ease. Therefore, an SSD using a nonvolatile memory device as a storage medium is mainly used for replacing an HDD.

### SUMMARY

A data storage system having a bridge chipset is described herein.

In one embodiment of the present invention, a data storage system includes: a data storage medium configured to store data; a main controller configured to control an operation of the data storage medium; and a bridge chipset configured to convert a signal provided from the main controller according to a control information provided from an external source to the data storage medium and the main controller and to provide the converted signal to the data storage medium.

In another embodiment of the present invention, there is provided a bridge chipset configured to convert a signal provided from a memory controller according to a control information provided from an external source to the memory controller and a memory device and to provide the converted signal to the memory device.

### BRIEF DESCRIPTION OF THE DRAWINGS

Features, aspects, and embodiments are described in conjunction with the attached drawings, in which:

FIG. 1 is a block diagram illustrating a data storage system having a bridge chipset according to one embodiment;

FIG. 2 is a block diagram illustrating a data storage system having a bridge chipset according to another embodiment;

FIG. 3 is a block diagram illustrating the bridge chipset according to the embodiment;

FIGS. 4 and 5 are diagrams explaining an operation mode change of the data storage system according to the embodiment;

FIGS. 6 and 7 are diagrams explaining another operation mode change of the data storage system according to the embodiment;

FIG. 8 is a block diagram illustrating an SSD including the bridge chipset according to the embodiment; and

FIG. 9 is a block diagram illustrating a computer system in which the data storage system according to the embodiments is mounted.

### DETAILED DESCRIPTION

Hereinafter, a bridge chipset and a data storage system having the same according to the present invention will be described below with reference to the accompanying drawings through various embodiments.

Various embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The drawings are not necessarily to scale and in some instances, proportions may have been exaggerated in order to clearly illustrate features of the embodiments. In this specification, specific terms have been used. The terms are used to describe the present invention, and are not used to qualify the sense or limit the scope of the present invention.

In this specification, ‘and/or’ represents that one or more of components arranged before and after ‘and/or’ is included. Furthermore, ‘connected/coupled’ represents that one component is directly coupled to another component or indirectly coupled through another component. In this specification, a singular form may include a plural form as long as it is not specifically mentioned in a sentence. Furthermore, ‘include/comprise’ or ‘including/comprising’ used in the specification represents that one or more components, steps, operations, and elements exists or are added.

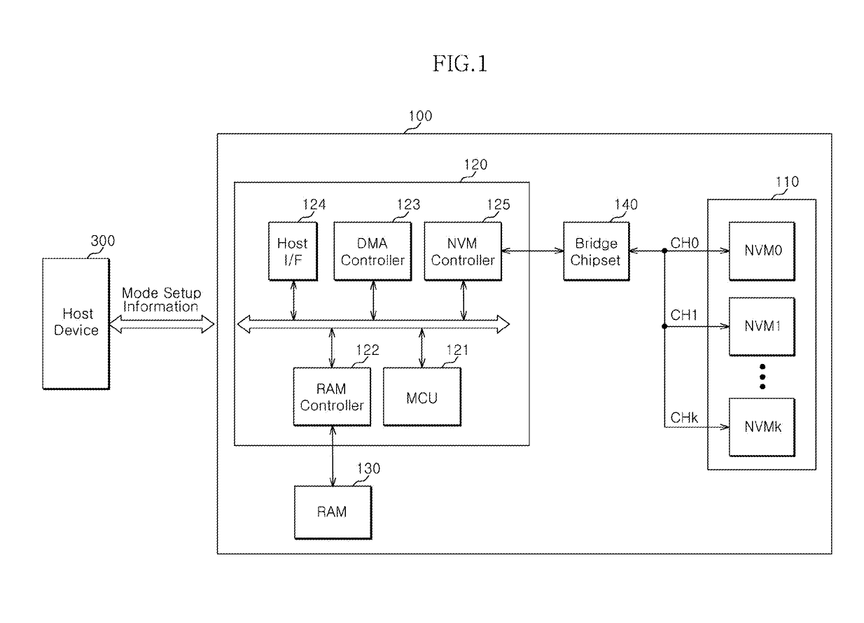

FIG. 1 is a block diagram illustrating a data storage system having a bridge chipset according to an embodiment. Referring to FIG. 1, the data storage system 100 includes a data storage medium 110, a main controller 120, a RAM 130, and a bridge chipset 140. However, the components of the data storage system 100 are not limited to the above-described components. For example, the data storage system 100 may further include an auxiliary power circuit (for example, a super capacitor) for providing temporary power to prepare for sudden power off.

The data storage medium 110 includes a plurality of nonvolatile memory devices NVM0 to NVMk coupled to a plurality of channels CH0 to CHk, respectively. Each of the nonvolatile memory devices NVM0 to NVMk may include various types of memory cell transistors. For example, each of the nonvolatile memory devices NVM0 to NVMk may include any one of the nonvolatile memory devices such as a flash memory device, a NAND flash memory device, a ferroelectric RAM (FRAM), a magnetic RAM (MRAM), and a phase change RAM (PRAM), depending on the structure of the memory cell transistors.

Each of the memory cells in the nonvolatile memory devices NVM0 to NVMk may be a single level cell (SLC), which is configured to store one-bit data. Each of the memory cells may be a multi-level cell (MLC) capable of storing a data for two-bits or more-than-two bits. An MLC is programmable to have a threshold voltage corresponding to any one of an erase state and a plurality of program states according to the multi-bit data. Each of the nonvolatile memory devices NVM0 to NVMk may include a hybrid nonvolatile memory device, which may operate in an SLC manner or an MLC manner.

The main controller 120 is coupled to a host device 300. Furthermore, the main controller 120 is coupled to the data storage medium 110 through the bridge chipset 140. The main controller 120 is configured to access the data storage medium 110 in response to a request from the host device 300. For example, the main controller 120 is configured to control the read, program, and erase operations of the data storage medium 110.

The main controller 120 includes, inter alia, a micro controller unit (MCU) 121, a RAM controller 122, a direct memory access (DMA) controller 123, a host interface 124, and a nonvolatile memory device (NVM) controller 125. However, the components of the main controller 120 are not limited to the above-described components. For example, the main controller 120 may further include a ROM for storing the code data required for an initial booting operation, a working memory device for temporarily storing the data required for an operation of the MCU, and an error correction code (ECC) unit for detecting and correcting an error of the data provided form the data storage medium 110.

The MCU 121 is configured to control the overall operations of the main controller 120. The MCU 121 is configured to drive the firmware for controlling the overall operations of the main controller 120. The firmware may be loaded into a working memory device, i.e., the RAM 130 and then driven. The MCU 121 is configured to access the RAM 130 through the RAM controller 122.

The RAM 130 may operate as a buffer memory device, if necessary. For example, the RAM 130 may store a set of data, temporarily, before storing the data in the data storage medium 110. Furthermore, the RAM 130 may temporarily store the data read from the data storage medium 110. The data stored in the RAM 130 may be transmitted to the data storage medium 110 or the host device 300 according to the control of the MCU 121. The data transmission operation of the RAM 130 operating as a buffer memory device is performed through the DMA controller 123.

The host interface 124 may be configured to interface with the main controller 120 and the host device 300. For example, the host interface 124 may be configured to communicate with the host device 300 through one of various interface protocols such as, but not limited to, a Universal Serial Bus (USB) protocol, an Secure Digital (SD) card protocol, an Multimedia Card (MMC) protocol, a Peripheral Component Interconnection (PCI) protocol, a PCI-Express (PCI-E) protocol, a Parallel Advanced Technology Attachment (PATA) protocol, a Serial ATA (SATA) protocol, an Small Computer System Interface (SCSI) protocol, and an Integrated Drive Electronics (IDE) protocol.

The NVM controller 125 is configured to control the nonvolatile memory devices NVM0 to NVMk of the data storage medium 110 according to the control of the MCU 121. For example, the NVM controller 125 may provide commands, addresses, control signals, and the data for controlling the nonvolatile memory devices NVM0 to NVMk according to the control of the MCU 121.

The bridge chipset 140 may be coupled between the data storage medium 110 and the main controller 120. The bridge chipset 140 is configured to change the operation mode or the operational characteristic of the data storage medium 110 according to the control information provided from a unit outside of the data storage system 100, for example, the mode setup information may be provided from the host device 300.

For example, the bridge chipset 140 may be configured to convert a command, an address, or a control signal (for example, a read control signal and a program control signal) provided from the main controller 120 according to the mode setup information provided from the host device 300. Furthermore, the bridge chipset 140 may be configured to provide the converted command, address, or control signal to the data storage medium 110. When the operation mode or the operational characteristic of the data storage medium 110 is changed according to the converted command, address, or control signal provided from the bridge chipset 140, the operation mode or the operational characteristics of the data storage system 100 may also be changed. For example, the performance and storage capacity of the data storage system 100 may be changed. This means that the operation mode or the operational characteristic of the data storage system 100 may be changed depending on the mode setup information, which is provided according to the intention of a user. The configuration and operation of the bridge chipset 140 will be described in detail with reference to FIGS.3 to 7.

When the mode setup information is provided from the host device 300, the MCU 121 may partially change the configuration of the firmware for controlling the overall operations of the main controller 120 according to the mode setup information. For example, the host device 300 is assumed to have transmitted, for illustration purposes, the mode setup information for setting the storage capacity of the data storage system 100. In this case, the MCU 121 may reset the storage capacity of the data storage system 100 by updating the logical to physical mapping table in the firmware. Furthermore, the MCU 121 may update the ID information on the storage capacity of the data storage system 100 and provide the updated ID information to the host device 300.

The data storage medium 110 and the main controller 120 may be integrated into a single semiconductor device, thereby forming a memory card. For example, the data storage medium 110 and the main controller 120 may be integrated into one semiconductor device, thereby forming a personal computer memory card international association (PCMCIA) card, a compact flash (CF) card, a smart media card, a USB memory stick, a multi-media card (MMC, RS-MMC, or MMC-micro), an SD card (SD, Mini-SD, or Micro-SD), or a universal flash storage (UFS) card. As another example, the data storage medium 110 and the main controller 120 may be integrated into one semiconductor device, thereby forming a solid state drive (SSD).

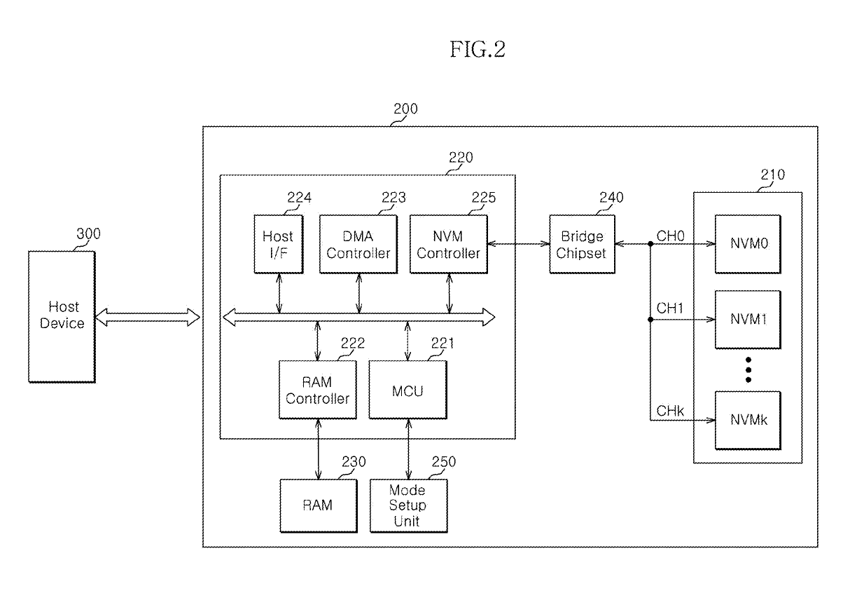

FIG. 2 shows a variation of a block diagram illustrating a data storage system having a bridge chipset according to an embodiment of the present invention. Referring to FIG. 2, the data storage system 200 includes, inter alia, a data storage medium 210, a main controller 220, a RAM 230, a bridge chipset 240, and a mode setup unit 250.

The data storage medium 210, the main controller 220, the

RAM 230, and the bridge chipset 240 of the data storage system 200 shown in FIG. 2 may share the same configurations as the data storage medium 110, the main controller 120, the RAM 130, and the bridge chipset 140 of the data storage system 100 shown in and described with respect to FIG. 1 and is capable of performing the substantially similar or even the same operations. Therefore, the detailed descriptions of the data storage medium 210, the main controller 220, the RAM 230, and the bridge chipset 240 will be omitted herein, in order to simplify the explanation.

The mode setup unit 250 is configured to receive the mode setup information, which is provided according to the intention of a user. FIG. 1 illustrates that the mode setup information is provided to the data storage system 100 through the host device 300. In the data storage system 200 illustrated in FIG. 2, however, the mode setup information is provided through the mode setup unit 250. The mode setup unit 250 may include hardware input devices such as, for example, a jumper, a switch, and a button.

FIG. 3 is a block diagram illustrating the bridge chipset 140 according to an embodiment of the present invention. As described above with reference to FIG. 1, the bridge chipset 140 according to an embodiment of the present invention is configured to convert a command, an address, or a control signal (for example, a read and program control signal) provided from the main controller 120 according to the mode setup information provided from the host device 300. Furthermore, the bridge chipset 140 is configured to provide the converted command, address, or control signal to the data storage medium 110. That is, the bridge chipset 140 performs a function of converting a command, an address, or a control signal between the NVM controller 125 and the data storage medium 110. Therefore, although different kinds of nonvolatile memory devices (for example, the nonvolatile memory devices having different characteristics or the nonvolatile memory devices manufactured by different makers) are included in the data storage medium 110, the main controller 120 may perform a normal control operation using the bridge chipset 140 without changing the firmware.

Referring to FIG. 3, the bridge chipset 140 include, inter alia, a mode setup register 141, a command converting unit 142, an address converting unit 143, and a control signal converting unit 144. The command converting unit 142, the address converting unit 143, and the control signal converting unit 144 may be implemented in an hardware such as a digital circuit, an analog circuit, or a combination of digital and analog circuits. As another example, the command converting unit 142, the address converting unit 143, and the control signal converting unit 144 may be implemented in software, which may be driven according to the control of the main controller 120. As another example, the command converting unit 142, the address converting unit 143, and the control signal converting unit 144 may be implemented in a combination of hardware and software.

The mode setup register 141 is configured to store mode setup information, which may be provided from an external source. The operations of the command converting unit 142, the address converting unit 143, and the control signal converting unit 144 are set according to the mode setup information stored in the mode setup register 141.

The command converting unit 142 is configured to convert a command, which is provided from the main controller 120 to control the data storage medium 110 according to the mode setup information. Furthermore, the command converting unit 142 is configured to provide the converted command to the data storage medium 110.

The address converting unit 143 is configured to convert an address which is provided from the main controller 120 to access the data storage medium 110 according to the mode setup information. Furthermore, the address converting unit 143 is configured to provide the converted address to the data storage medium 110.

The control signal converting unit 144 is configured to convert a control signal, which is provided from the main controller 120 to control the data storage medium 110 according to the mode setup information. Furthermore, the control signal converting unit 144 is configured to provide the converted control signal to the data storage medium 110. Alternatively, the control signal converting unit 144 may be configured to generate a new control signal according to the mode setup information and provide the generated control signal to the data storage medium 110. Alternatively, the control signal converting unit 144 may be configured to filter a control signal provided from the main controller 120 such that the control signal is not transmitted to the data storage medium 110 according to the mode setup information.

The control signal for controlling the data storage medium 110 includes, inter alia, the control signals for controlling the operation of the data storage medium 110 such as a write enable signal /WE, a read enable signal /RE, and a data storage signal DQS.

The control signal converting unit 144 may include the circuits capable of converting the cycle of the control signal provided from the main controller 120. For example, the control signal converting unit 144 may include the circuits capable of converting the signal timing, such as a delay circuit and a clock generator.

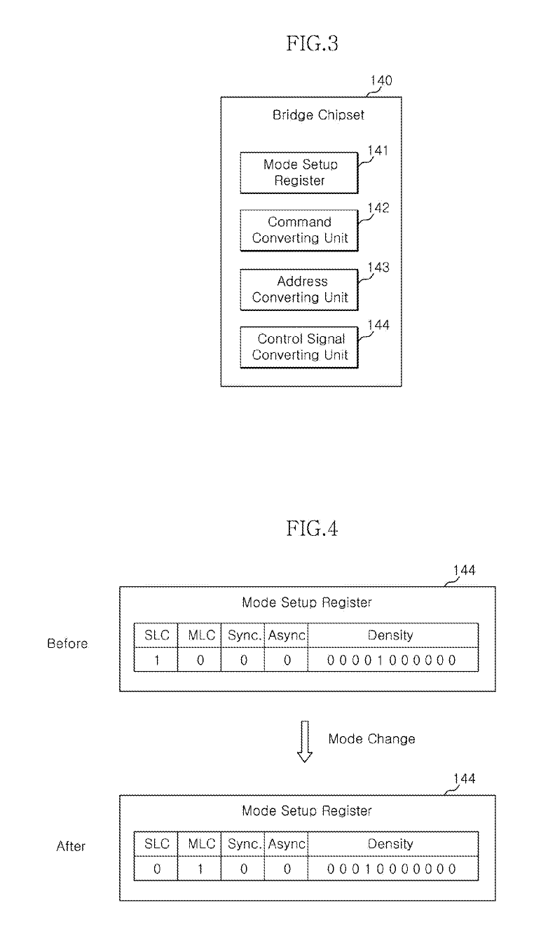

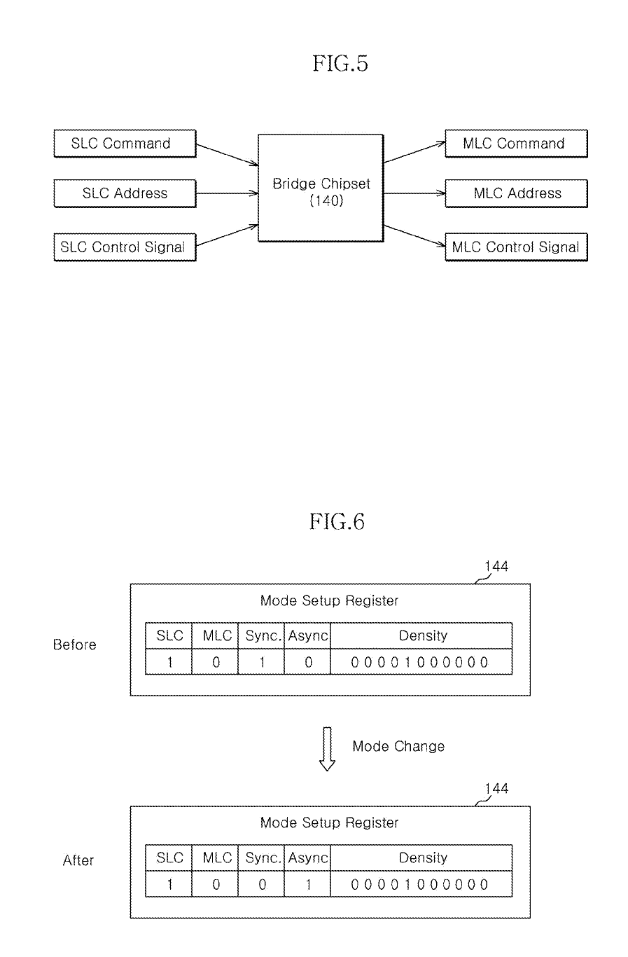

FIGS. 4 and 5 are diagrams for explaining an example of an operation mode change of the data storage system according to an embodiment of the present invention. In FIGS. 4 and 5, for illustration purposes, it is assumed that the data storage system 100 is set in such a manner that, in the initial stage, it is set to have an enhanced performance (for example, increased speed or improved data stability) as opposed to an increased capacity (that is, increased data storage space), and that, after the mode change, it is set to have the increased capacity as opposed to an improved performance.

That is, referring to FIG. 4, the mode setup register 144 of the bridge chipset 140 at the initial stage may be set in such a manner that the data storage medium 110 operates as an SLC and has a capacity of 64 GB. After the mode change, the mode setup register 144 of the bridge chipset 140 may be set in such a manner that the data storage medium 110 operates as an MLC and has a capacity of 128 GB according to the provided mode setup information.

According to such setup, as illustrated in FIG. 5, the bridge chipset 140 converts a command, an address, and a control signal provided from the main controller 120. For example, the command converting unit 142 of the bridge chipset 140 converts an SLC command provided from the main controller 120 into an MLC command. The SLC command may include a specific command such as a sequential read command of a nonvolatile memory device, which is used only in an SLC nonvolatile memory device. In this case, the command converting unit 142 may convert the sequential read command into a normal read command used in an MLC nonvolatile memory device.

As another example, the address converting unit 143 of the bridge chipset 140 may convert an SLC address provided from the main controller 120 into an MLC address. Since the capacity of the data storage system 100 is expanded from 64 GB to 128 GB, the MLC address may include an address expanded from that of the SLC address.

As another example, the control signal converting unit 144 of the bridge chipset 140 may convert an SLC control signal provided from the main controller 120 into an MLC control signal. The MLC control signal may include a control signal delayed from the SLC control signal.

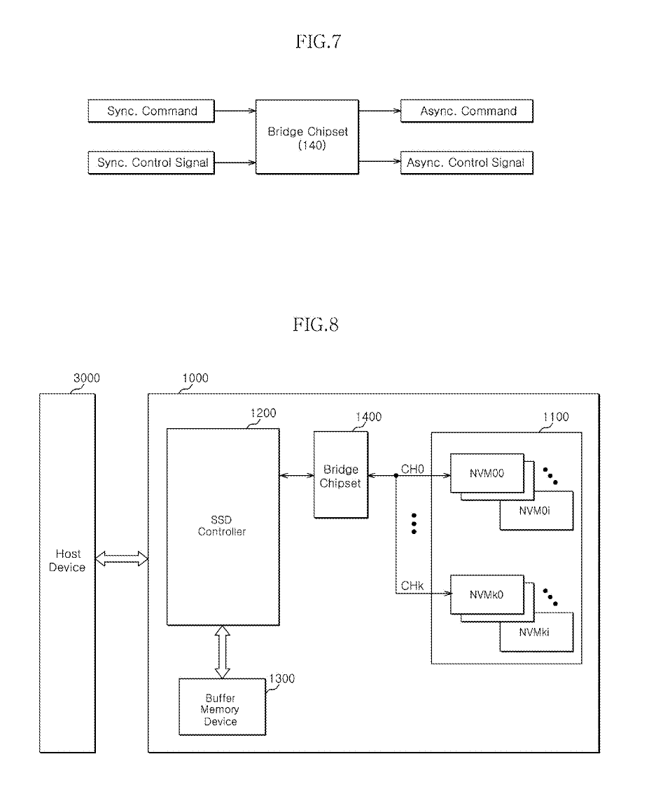

FIGS. 6 and 7 are diagrams related to explaining another example of an operation mode change of the data storage system according to an embodiment of the present invention. In FIGS. 6 and 7, for illustration purposes, it is assumed that the data storage system 100 is set in such a manner that, in the initial stage it is set to have an increased speed as opposed to improved data stability, and that, after the mode change, it is set to have the improved data stability as opposed to the increased speed.

That is, referring to FIG. 6, the mode setup register 144 of the bridge chipset 140 at the initial stage may be set in such a manner that the data storage medium 110 operates an SLC and operates in a synchronous mode. After the mode change, the mode setup register 144 of the bridge chipset 140 may be set in such a manner that the data storage medium 110 operates an MLC and is operates in an asynchronous mode, according to the provided mode setup information. According to such setup as illustrated in FIG. 7, the bridge setup 140 converts a command and a control signal provided from the main controller 120.

For example, the command converting unit 142 of the bridge chipset 140 may convert a synchronous command provided from the main controller 120 into an asynchronous command. In order to operate a nonvolatile memory device in a synchronous or asynchronous mode, a command for setting a parameter should be transmitted. In this case, the command converting unit 142 may convert a parameter setup value for a synchronous operation into a parameter setup value for an asynchronous operation.

As another example, the control signal converting unit 144 of the bridge chipset 140 may convert a synchronous control signal provided from the main controller 120 into an asynchronous control signal. The synchronous control signal may include a data strobe signal for data input/output. In this case, the control signal converting unit 144 may filter the data storage signal, and generate a new control signal corresponding to the data storage signal.

FIG. 8 is a block diagram illustrating an SSD including the bridge chipset according to an embodiment of the present invention. Referring to FIG. 8, the SSD 1000 includes, inter alia, a data storage medium 1100, an SSD controller 1200, a buffer memory device 1300, and a bridge chipset 1400.

The SSD 1000 operates in response to an access request of a host device 3000. That is, the SSD controller 1200 is configured to access the data storage medium 1100 in response to a request from the host device 3000. For example, the SSD controller 1200 is configured to control the read, program, and erase operations of the data storage medium 1100.

The buffer memory device 1300 is configured to operate as a working memory device of the SSD controller 1200. Furthermore, the buffer memory device 1300 is configured to temporarily store data which are to be stored in the data storage medium 1100. Furthermore, the buffer memory device 1300 is configured to temporarily store data read from the data storage medium 1100. The data stored in the buffer memory device 1300 are transmitted to the data storage medium 1100 or the host device 3000 according to the control of the SSD controller 1200.

The data storage medium 1100 includes a plurality of nonvolatile memory devices NVM00 to NVM0i and NVMk0 to NVMki. The SSD controller 1200 is coupled to the data storage medium 1100 through a plurality of channels CH0 to CHk. The plurality of nonvolatile memory devices NVM00 to NVM0i and NVMk0 to NVMki are coupled to the respective channels CH0 to CHk.

The bridge chipset 1400 may have substantially similar or even same configuration as the bridge chipset 140 described in FIGS. 1 to 3 and may perform substantially similar or even the same operations. That is, for example, the bridge chipset 1400 can be configured to change the operation mode or operational characteristic of the data storage medium 1100 according to the control information provided from the outside of the SSD 1000. For example, the bridge chipset 1400 is configured to convert a command, an address, or a control signal provided from the SSD controller 1200 according to the mode setup information. Furthermore, the bridge chipset 1400 is configured to provide the converted command, address, or control signal to the data storage medium 1100. Furthermore, when the operation mode or operation characteristic of the data storage medium 1100 is changed according to the converted command, address, or control signal provided from the bridge chipset 1400, the operation mode or operation characteristic of the SSD 1000 (for example, performance, storage capacity or the like) may be changed.

As described with reference to FIG. 1, it can be easily understood that, when the mode setup information is provided, the SSD controller 1200 may partially change the setup of the firmware for controlling the overall operations of the SSD 1000 according to the mode setup information.

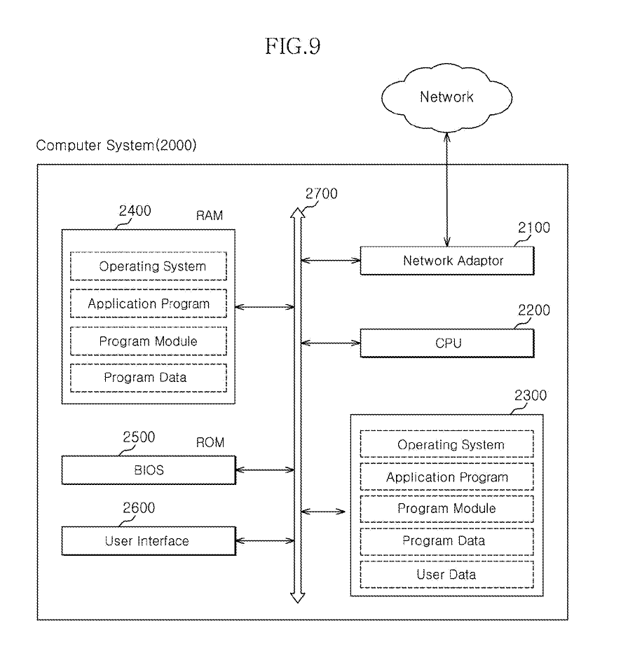

FIG. 9 is a block diagram illustrating a computer system in which the data storage system according to an embodiment is mounted.

Referring to FIG. 9, the computer system 2000 includes a network adapter 2100, a central processing unit (CPU) 2200, a data storage device 2300, a RAM 2400, a ROM 2500, and a user interface 2600, which are electrically coupled to a system bus 2700. The data storage device 2300 may include any one of the data storage systems 100 and 200 and the SDD 1000 illustrated in FIGS. 1-2 and 8, respectively.

The network adapter 2100 is configured to provide an interface between the computer system 2000 and the external network or networks. The CPU 2200 is configured to perform overall arithmetic operations for driving an operating system or application programs residing in the RAM 2400. The data storage device 2300 is configured to store overall data required by the computer system 2000. For example, the data storage device 2300 may store the operating system, application programs, various program modules, program data, and user data for driving the computer system 2000.

The RAM 2400 may be used as a working memory device of the computer system 2000. During booting, the operating system, the application programs, and the various program modules, which are read from the data storage device 2300, and program data required for driving the programs are loaded into the RAM 2400. The ROM stores a basic input/output system (BIOS) which is activated before the operation system is driven. Through the user interface 2600, information is exchanged between the computer system 2000 and a user.

In addition, the computer system 2000 may further include a battery or modem. Furthermore, although not illustrated in the drawing, application chipsets, a camera image process (CIS) and the like may be further included in the computer system 2000.

While certain embodiments have been described above, it will be understood to those skilled in the art that the embodiments described are by way of example only. Accordingly, the bridge chipset and the data storage system described herein should not be limited based on the described embodiments. Rather, the bridge chipset and the data storage system described herein should only be limited in light of the claims that follow when taken in conjunction with the above description and accompanying drawings.

What is claimed is:

1. A data storage system comprising:
a data storage medium configured to store data;
a main controller configured to control an operation of the data storage medium; and
a bridge chipset configured to convert a signal provided from the main controller according to a control information provided from an external source to the data storage medium and the main controller and to provide the converted signal to the data storage medium.

2. The data storage system according to claim 1, wherein the control information provided from the external source comprises an information for changing one or both of an operation mode and an operational characteristic of the data storage medium.

3. The data storage system according to claim 1, wherein the control information provided from the external source is a mode set up information and one or both of the operation mode and the operational characteristic are changed in the data storage system depending on the mode setup information.

4. The data storage system according to claim 1, wherein the data storage medium comprises at least one nonvolatile memory device.

5. The data storage system according to claim 4, wherein the nonvolatile memory device comprises a NAND flash memory device.

6. The data storage system according to claim 4, wherein an operation mode of the nonvolatile memory device is divided into both a synchronous operation mode and an asynchronous operation mode.

7. The data storage system according to claim 4, wherein an operation characteristic of the nonvolatile memory device is determined on the basis of the number of data bits stored per memory cell.

8. The data storage system according to claim 7, wherein the operation characteristic of the nonvolatile memory device is determined on the basis of a storage capacity of the nonvolatile memory device.

9. The data storage system according to claim 1, wherein the bridge chipset comprises:
a command converting unit configured to convert a command which is provided from the main controller to control the data storage medium, according to the control information;
an address converting unit configured to convert an address which is provided from the main controller to access the data storage medium, according to the control information; and
a control signal converting unit configured to convert a control signal which is provided from the main controller to control the data storage medium, according to the control information.

10. The data storage system according to claim 9, wherein the control signal converting unit comprises a delay circuit configured to delay timing of the control signal.

11. The data storage system according to claim 9, wherein the control signal converting unit comprises a clock generator configured to generate a new control signal based on the control signal.

12. The data storage system according to claim 9, wherein the bridge chipset further comprises a register configured to store the control information.

13. The data storage system according to claim 1, further comprising an input device configured to receive the control information provided from the external source to the data storage medium and the main controller.

14. The data storage system according to claim 13, wherein the input device comprises any one of a jumper, a switch, and a button.

15. The data storage system according to claim 1, wherein the main controller comprises:
a micro controller unit(MCU) configured to control overall operations of the main controller;
a host interface configured to interface with the external source to the data storage medium and the main controller; and
a data storage medium controller configured to control the data storage medium according to control of the MCU.

16. The data storage system according to claim 15, further comprising a random access memory(RAM) device configured to operate as at least one of a working memory device and a buffer memory device.

17. The data storage system according to claim 16, wherein the main controller further comprises:
a RAM controller configured to control the RAM device; and
a direct memory access(DMA) controller configured to control data transmission between the RAM controller and the data storage medium controller.

18. A bridge chipset configured to convert a signal provided from a memory controller according to a control information provided from an external source to the memory controller and a memory device and to provide the converted signal to the memory device.

19. The bridge chipset according to claim 18, wherein the control information provided from the external source comprises an information for changing one or both of a data storage capacity and an operational characteristic of the memory device.

20. The bridge chipset according to claim 18, comprising:
a command converting unit configured to convert a command which is provided from the memory controller to control the memory device, according to the control information;
an address converting unit configured to convert an address which is provided from the memory controller to access the memory device, according to the control information; and
a control signal converting unit configured to convert a control signal which is provided from the memory controller to control the memory device, according to the control information.

21. The bridge chipset according to claim 20, further comprising a register configured to store the control information.
